(19) United States
(12) Patent Application Publication
(10) Pub. No.: US 2012/0158422 A1
(43) Pub. Date: Jun. 21, 2012

(54) METHODS AND SYSTEMS FOR SCHEDULING APPOINTMENTS IN HEALTHCARE SYSTEMS

(75) Inventors: Luke A. Burnham, Boston, MA (US); George C. Brown, Southborough, MA (US)

(73) Assignee: General Electric Company, Schenectady, NY (US)

(21) Appl. No.: 12/974,990

(22) Filed: Dec. 21, 2010

(51) Int. Cl. G06Q 10/00; G06Q 50/00

(52) U.S. Cl. 705/2

(57) ABSTRACT

Methods and systems for scheduling appointments in healthcare environments are described. An example computer implemented method of automatically scheduling a medical appointment includes enabling a first device associated with a patient to communicate with a provider scheduling system and inputting a patient schedule onto the provider scheduling system. The example method includes identifying a time slot, using a computer, at which both the patient schedule and a provider schedule have an open time slot and identifying a time and a location of a first appointment proximate to the open time slot based on the patient schedule. The example method includes determining an estimated travel time between the location of the first appointment and a location of a second appointment and determining a patient availability to schedule the second appointment in the open time slot based on the time of the first appointment and the estimated travel time between the location of the first appointment and the location of the second appointment.

### BACKGROUND

Healthcare environments, such as hospitals and clinics, typically include scheduling systems. To schedule an appointment, a patient may have a conversation with a healthcare practitioner to identify a mutually agreeable time at which to schedule an appointment. In some examples, the patient's schedule saved at their workstation may include an entry relating to an upcoming appointment. The workstation may remind the patient of the upcoming appointment using a pop-up window a fixed amount of time ahead of the appointment start time.

### SUMMARY

An example computer-implemented method of scheduling a follow-up medical appointment includes enabling a mobile device associated with a patient to communicate with a provider scheduling system and inputting a patient schedule onto the provider scheduling system. The example method includes identifying a time slot, using a computer, at which both the patient schedule and a provider schedule have an open time slot and identifying an end time and a location of a first appointment of the patient preceding the open time slot based on the patient schedule. The example method includes determining an estimated travel time between the location of the first appointment and a location of a second appointment and determining a patient availability to schedule the second appointment in the open time slot based on the end time of the first appointment and the estimated travel time from the location of the first appointment to the location of the second appointment.

An example computer implemented method of automatically scheduling a medical appointment includes enabling a first device associated with a patient to communicate with a provider scheduling system and inputting a patient schedule onto the provider scheduling system. The example method includes identifying a time slot, using a computer, at which both the patient schedule and a provider schedule have an open time slot and identifying a time and a location of a first appointment proximate to the open time slot based on the patient schedule. The example method includes determining an estimated travel time between the location of the first appointment and a location of a second appointment and determining a patient availability to schedule the second appointment in the open time slot based on the time of the first appointment and the estimated travel time between the location of the first appointment and the location of the second appointment.

An example tangible computer-readable storage medium including executable instructions for execution using a processor, wherein the instructions, when executed, provide a scheduling system to schedule a medical appointment. The system includes an identifier to identify a time slot at which both the patient schedule and the provider schedule have an open time slot, the patient schedule or a copy thereof being stored on a memory accessible by the processor. The example tangible computer-readable storage medium includes a scanner to scan at least a portion of the patient schedule to identify an end time and a location of a first appointment prior to the open time slot and a processer to determine a patient availability to schedule a second appointment in the open time slot based on the end time of the first appointment and an estimated travel time from the first appointment to the second appointment.

### BRIEF DESCRIPTION OF THE DRAWINGS

FIG. 1 is a block diagram of an example medical scheduling or appointment system.

FIG. 2 is a block diagram of an example apparatus that may be used to implement the examples described herein.

FIGS. 3-4 are flow diagrams of example methods that can be used to implement the examples described herein.

FIG. 5 is a block diagram of an example reminder system.

FIG. 6 is a block diagram of an example apparatus that may be used to implement the examples described herein.

FIGS. 7-8 are flow diagrams of example methods that can be used to implement the examples described herein.

FIG. 9 is a schematic illustration of an example processor platform that may be used and/or programmed to implement any or all of the example methods and systems described herein.

The foregoing summary, as well as the following detailed description of certain examples, will be better understood when read in conjunction with the appended drawings. For the purpose of illustrating the examples described herein, certain examples are shown in the drawings. It should be understood, however, that the present disclosure is not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

When any of the appended claims are read to cover a purely software and/or firmware implementation, at least one of the elements in at least one example is hereby expressly defined to include a tangible medium such as a memory, DVD, CD, Blu-ray, etc. storing the software and/or firmware.

The example methods and apparatus described herein relate to scheduling systems that efficiently and automatically synchronize provider and patient electronic schedules to identify a mutually agreeable appointment(s). In contrast to some known examples, the examples described herein base the availability of the patient on their schedule prior to the suggested appointment time, their schedule preceding the suggested appointment time and/or other data as well as an opening in the patient's electronic schedule at the suggested appointment time. Thus, instead of assuming the patient's availability solely on identifying an open time slot in the patient's electronic schedule, the examples described herein are aware of and take into account end times and/or locations of prior appointment(s) in the patient's schedule and/or start times and/or locations of subsequent appointment(s) in the patient's schedule when identifying a mutually agreeable appointment(s).

In some examples, a mutually agreeable appointment is identified by enabling a short range communication protocol such as Bluetooth® of a mobile device to communicate with a healthcare scheduling system. Once enabled, the healthcare scheduling system may input and/or temporarily store the patient's electronic schedule from the mobile device. The electronic schedule may be associated with Microsoft Outlook©. The healthcare scheduling system may then compare the provider's schedule and the patient's schedule to identify when both the provider and the patient are available.

In some examples, based on a suggested follow-up appointment time (e.g., four-weeks from the current date), the healthcare scheduling system identifies an open time slot on the provider's schedule and then determines if the patient's schedule also has an open time slot at the identified open-provider time slot. Additionally or alternatively, when determining the patient's availability, the healthcare scheduling system may access other schedules (e.g., provider schedules accessible by the healthcare scheduling system) to identify appointments in which the patient is scheduled. If any additional appointments of the patient are identified when accessing the other schedules, those appointments and any information related thereto may be considered and/or integrated into the patient's schedule stored at the healthcare scheduling system.

If both the provider and the patient are available, the healthcare scheduling system may then determine the patient's location prior to this identified open time slot and/or subsequent to this identified open time slot. For example, the healthcare scheduling system may scan the patient's schedule for an appointment prior to the identified open time slot and, once identified, extract location identifying information and/or end time information associated with this identified prior appointment. Additionally or alternatively, the healthcare scheduling system may scan the patient's schedule for an appointment subsequent to the identified open time slot and, once identified, extract location identifying information and/or start time information associated with this identified subsequent appointment. The location identifying information may be stored at a location field of the identified prior and/or subsequent appointment and may include an address, a ZIP code, a building name, a floor or suite, a department name (e.g., Radiology) and/or different locations within a hospital and/or other information.

The location identifying information and/or extracted information such as the end time of the prior identified appointment may be used by the healthcare scheduling system and/or another system (e.g., a third party navigation system) to determine if the patient is able to make the suggested appointment time. For example, based on the location identifying information, the healthcare scheduling system may input this information into a navigation system such as Google Maps© to calculate an estimated travel time from the identified prior appointment at a first location to the follow-up appointment at a second location. This estimated travel time may be factored into the patient's schedule by adding the travel time to the end time of the identified prior appointment. Additionally or alternatively, based on the location identifying information, the healthcare scheduling system may input this information into a navigation system such as Google Maps© to calculate an estimated travel time from the follow-up appointment at a first location to the identified subsequent appointment at a second location. This estimated travel time may be factored into the patient's schedule by adding the travel time to an estimated end time of the follow-up appointment and/or to the start time of the identified subsequent appointment.

If the healthcare scheduling system determines that there is sufficient time for the patient to make the follow-up appointment after factoring in the travel time to and/or from the identified appointment, the healthcare scheduling system may schedule the patient in that appointment. However, if the healthcare scheduling system determines that there is insufficient time for the patient to make the follow-up appointment after factoring in the travel time, the healthcare scheduling system may find another open time slot to possibly schedule the follow-up appointment in using the methods described above.

If the identified prior appointment and/or the location identifying information is related to a medical procedure such as having an X-ray taken, the healthcare scheduling system may assume that the identified prior appointment is taking place at the Radiology department. In some examples, the healthcare scheduling system or a database associated therewith may have a travel time chart including travel times between different departments within a healthcare facility. Thus, if the identified prior appointment is at the healthcare facility, instead of interacting with the navigation system to estimate the travel time between the two appointments, the healthcare scheduling system may instead retrieve the estimated travel time from the travel time chart.

If no location identifying information is extracted from the identified prior and/or subsequent appointment, the healthcare scheduling system may assume a travel time based on spacing between other appointments on the patient's electronic schedule. Alternatively, the healthcare scheduling system may use and/or input a default location(s) for the patient. The default location may be based on user input, information stored at and/or accessible by the healthcare scheduling system and/or a time of day at which the identified prior and/or subsequent appointment is scheduled. For example, if the identified appointment is scheduled between 9:00 am and 5:00 pm, the healthcare scheduling system may assume that the patient is at their place of work and if the identified appointment is at another time other than between 9:00 am and 5:00 pm, the healthcare scheduling system may assume that the patient is at their home.

In some examples, the estimated travel time may be at least partially based on factors other than the distance between the two locations. The other factors may include the patient's mode of transportation (e.g., walking, public transit, car, etc.), the patient's diagnosis, the patient's age and/or physical classification (e.g., usage of mobility aids, having a broken leg, intellectual disability, etc.). Information relating to the other factors may be obtained from patient input, the patient's medical record stored at and/or associated with the provider and/or the mobile device. In some examples, a default mode of transportation may be used. The default mode of transportation may be based on the location of the healthcare facility where the follow-up appointment is to be had. For example, if the healthcare facility is located in a rural setting, the default mode of transportation may be by car and if the healthcare facility is located in an urban setting, the default mode of transportation may be by public transit.

The example methods and apparatus described herein additionally relate to reminder systems that provide dynamic scheduling reminders based on a location of a user, the user's mode of transportation and/or a start time of an upcoming appointment. In contrast to some known examples, the examples described herein factor in travel time to the user's next appointment based on the user's current location and the location of the next appointment. Thus, instead of reminding the user at a fixed time ahead of the next appointment (e.g., 15-minutes), the examples described remind the user of the next appointment with sufficient time to ensure that the user has adequate travel time to make it to the next appointment even if the user's current location is dynamically changing.

In some examples, the reminder system identifies a user's next appointment by scanning the user's schedule stored at the user's mobile device. Once identified, the reminder system may extract location identifying information and/or start time information from the identified next appointment. The start time information may be stored at a start time field of the next appointment. The location identifying information may be stored at a location field of the next appointment and may include an address, a ZIP code, a building name, a floor or suit, a department name (e.g., Radiology) and/or different locations within a hospital and/or other information. If no location identifying information is extractable, the reminder system may base the location of the next appointment on a previous associated appointment. For example, if the user has a standing appointment the first of every month at 3:00 pm but none of the appointment entries specify a location, the example reminder system may determine the location of the next appointment based on the location of mobile device at the previous month's appointment at 3:00 pm, for example. Alternatively, if the user has a standing appointment the first of every month at 3:00 pm and the upcoming appointment does not specify a location, the example reminder system may determine the location of the next appointment based on location identifying information associated with and/or extracted from a previous appointment at 3:00 pm, for example.

In other examples, the reminder system may identify a user's next appointment by scanning and/or searching a healthcare schedule at a healthcare facility to identify a user(s) having an upcoming appointment. Once identified, the examples described may extract location identifying information of where the appointment is to be had and/or start time information from the identified next appointment. The location identifying information may be stored at a location field of the next appointment and may include an address, a ZIP code, a building name, a floor or suit, a department name (e.g., Radiology) and/or different locations within a hospital and/or other information. The start time information may be stored at a start time field of the next appointment.

In some examples, depending on a time period (e.g., 2-hours) between the current time and the identified start time, the reminder system may determine the location of the user. Once initiated, the location of the user and changes thereto may be determined by the reminder system on a regular basis (e.g., once per minute) and/or repetitiously until the start time of the appointment. The user's location may be determined using functionality of a mobile device (e.g., GPS) associated with the user. If the appointment is stored on a scheduling system at the mobile device, the reminder system may initiate identifying the user's location once the upcoming appointment is identified. If the appointment is stored on a scheduling system at a healthcare facility and the user is identified as having an upcoming appointment, the reminder system may notify the mobile device and/or convey information relating to the upcoming appointment to the mobile device of the respective user which in turn initiates identifying the user's location.

The location identifying information and/or extracted information such as the start time of the next appointment may be used by a mobile device, a healthcare system, the reminder system and/or another system (e.g., a third party navigation system) to determine if the user has sufficient time to make the next appointment. For example, based on the user's current location and the location of the next appointment, the reminder system may input this information into a navigation system such as Google Maps© to calculate an estimated travel time from the user's current location to the location of the next appointment. In some examples, the user's current location may be in a first city and the location of the next appointment may be in a second city. In some examples, the user's current location may be in a first office of a business and the location of the next appointment may be in a second office of the business.

The estimated travel time may be partially based on factors other than the distance between the two locations such as the user's mode of transportation, the time of day (e.g., rush hour), traffic conditions, etc. The user's mode of transportation may be determined based on user input, the user's location, the user's route and/or a user's rate of advancement between iterations of determining the user's location. For example, if the user's location is determined to be on a highway, the user's mode of transportation may be determined to be by automobile. Alternatively, if the user's location is determined to be on a bike path, the user's mode of transportation may be determined to be by bike. If the mobile device's rate of advancement is determined to be 40 mph, the user's mode of transportation may be determined to be by automobile.

If the reminder system determines that there is sufficient time and/or a difference between the current time and a start time of the next appointment is greater than a threshold of the estimated travel time, the user may not be reminded of the upcoming appointment. For example, if the time is currently 10:00 am, the user's next appointment starts at 11:00 am and the travel time from the user's current location to the next appointment is 15 minutes, the user may not be reminded of the next appointment. However, if the reminder system determines that there is insufficient time and/or a difference between the current time and the start time of the next appointment is within a threshold of the estimated travel time, the user may be reminded of the upcoming appointment. The user may be reminded of the upcoming appointment using functionality of the user's mobile device such as by pop-up window, text message, phone call, vibration, etc. For example, if the time is currently 10:00 am, the user's next appointment starts at 11:00 am and the travel time from the user's current location to the next appointment is 45 minutes, the user's mobile device may vibrate to remind the user of the next appointment.

If it is determined that the user has insufficient time (e.g., travel time) to make it to the next appointment on time, a notice (e.g., text message, e-mail, etc.) may be automatically conveyed, for example, from a mobile device associated with the user to a doctor's office where the appointment is to be held. In some examples, if a patient is unable to make it to the next appointment on time, a mobile device associated with the user may interact with a healthcare scheduling system to re-schedule the patient at a time when both the provider and the patient are available. For example, the example systems and methods described may automatically accommodate extenuating circumstances in which a patient misses their scheduled appointment and has not made arrangements with the doctor regarding the same.

In some examples, the user may tailor the threshold of being reminded of the upcoming appointment to their tolerance and/or preference for timeliness. For example, if two users are at the same location and each of their next appointments is at the same time and location and the first user prefers to be approximately 10 minutes early for all appointments and a second user prefers to be approximately 5 minutes early for all appointments, the first user may be within the threshold of being reminded of the upcoming appointment 5 minutes earlier than the second user. In some examples, the user may tailor the threshold of being reminded of upcoming appointments differently depending on the appointment type and/or information extracted from the appointment. For example, the user may prefer to be approximately 15 minutes early for appointments associated with new business meetings and the user may prefer to be 5 minutes early for all other appointments.

In some examples, the reminder system may factor in prep-times associated with the next appointment. For example, if a start time of the next appointment is at 11:00 am, but requires paperwork to be completed that takes approximately 10 minutes to complete, the reminder system may determine the start time of the next appointment as being at 10:50 am instead of 11:00 am. In such examples, if a reminder is conveyed to the user of the upcoming appointment based on the user's current location, the current time, and/or the user's mode of transportation, the reminder may specify that the appointment is scheduled for 11:00 am, but the user is to be at the appointment location 10 minutes early to complete necessary paper work.

In other examples, the example reminder systems provide dynamic scheduling reminders for equipment used during an appointment based on the equipment's current location, a travel time to move the equipment from its current location to the location of the next appointment in which the equipment is to be used and a start time of the next appointment.

In some examples, the reminder system identifies the next appointment where the machine (e.g., an X-ray machine, etc.) is to be used by scanning a schedule at a healthcare facility. Once the next appointment is identified, the reminder system may extract location identifying information (e.g., room number, department, etc.) and/or start time information associated with the next appointment.

In some examples, depending on a time period between the current time and the identified start time, the reminder system may determine the location of the machine. Once initiated, the location of the machine may be determined by the reminder system on a regular basis (e.g., once per minute) until the start of the appointment at which the machine is to be used. The location of the machine may be determined using any technology such as an RFID tag attached to the machine, a scanner that scans a bar code on the machine as the machine enters or leaves a room, a mobile device associated with and/or attached to the machine and/or a sensor that detects the machine's location within a facility.

The location identifying information and/or the extracted information such as the start time of the appointment in which the machine is to be used may be used by a mobile device, a healthcare system and/or the reminder system in connection with a travel time chart including travel times between different departments within a facility. Thus, in some examples, instead of interacting with the navigation system to estimate the travel time between two locations, the reminder system may retrieve the estimated travel time to move the machine between the locations from the travel time chart. In some examples, depending on the machine to be moved, the travel time between the two locations may be different. For example, if one of the machines has wheels and the other machine does not have wheels, the machine having wheels may be moved more quickly than the machine without wheels and, thus, the travel time chart will reflect the same.

If the reminder system determines that there is sufficient time and/or a difference between the current time and a start time of the next appointment in which the machine is to be used is greater than a threshold of the estimated travel time, a reminder may not be conveyed to a person responsible for moving the machine. However, if the reminder system determines that there is insufficient time and/or a difference between the current time and the start time of the next appointment in which the machine is to be used is within a threshold of the estimated travel time, a reminder may be conveyed to the person responsible for moving the machine. In some examples, the reminder may be conveyed to a central console (e.g., a computer) at which the person responsible for moving the machine sits. In some examples, the reminder may be conveyed to a mobile device associated with the person responsible for moving the machine. The reminder may include information such as the type of machine to be moved, an identifier (e.g., an assigned number) for that machine, the current location of the machine, the location of the appointment where the machine is to be used, any equipment (e.g., forklift) needed to move the machine, a start time of the appointment where the machine is to be moved, etc.

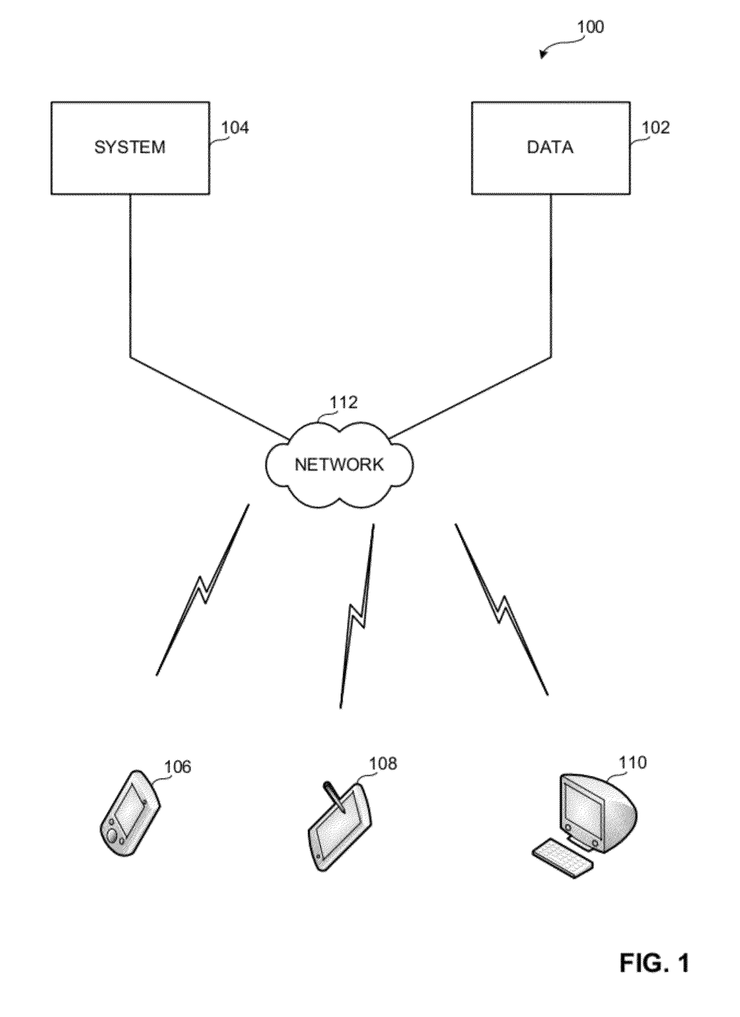

FIG. 1 depicts an example healthcare scheduling or appointment system 100 including a data store or source 102 and a system 104. One or both of the data source 102 and/or the system 104 may interact with a first access device 106, a second access device 108 and/or a third access device 110. In some examples, the data source 102 and/or the system 104 can be implemented in a single system. In some examples, the data source 102 and/or the system 104 can communicate with one or more of the access devices 106-110 via a network 112. In some examples, one or more of the access devices 106-110 can communicate with the data source 102 and/or the system 104 via the network 112 using, for example, a short range communication protocol such as Bluetooth®. The network 112 may be implemented by, for example, the Internet, an intranet, a private or personal network, a wired or wireless Local Area Network, a wired or wireless Wide Area Network, a cellular network and/or any other suitable network.

One or more of the access devices 106-110 may provide patient scheduling information and/or other data to the healthcare scheduling system 100 to facilitate identifying a time when both a provider and a patient associated with the respective access device 106-110 are available to schedule an appointment. In some examples, the data source 102 can receive patient scheduling information and/or other data from one of the access devices 106-110. In some examples, the system 104 can receive patient scheduling information and/or other data from one of the access devices 106-110. The data source 102 and/or the system 104 can be implemented using a system such as a PACS, RIS, HIS, CVIS, EMR, archive, data warehouse.

The access devices 106-110 can be implemented using a workstation (e.g., a laptop, a desktop, a tablet computer, etc.) or a mobile device, for example. Some mobile devices include smart phones (e.g., BlackBerry™, iPhone™, etc.), Mobile Internet Devices (MID), personal digital assistants, cellular phones, handheld computers, tablet computers (iPad™), etc., for example. The access devices 106-110 may be associated with a patient seeking to schedule, for example, a follow-up appointment.

In some examples, a patient may need to schedule a follow-up medical appointment. The process of identifying a time at which both the patient and the provider are available can be extremely time consuming especially when both the patient and the provider are only available during certain days and/or times. The amount of time needed to schedule a follow-up medical appointment is increased by the patient having to account for the location and/or time of other appointments on their schedule prior to determining their availability. For instance, if an open time slot for a follow-up medical appointment is at 10:00 am and the patient's schedule is free at that time, the patient is unable to immediately assume they are available to schedule in that appointment without taking into account other information from their schedule. For example, if the patient has an appointment between 9:00 am and 10:00 am twenty-minutes away from the location of the follow-up appointment, the patient will be unable to schedule for the 10:00 am appointment but may be able to schedule for a 10:30 am appointment if one happens to be available.

In such instances, using the examples described herein, one or more of the access devices 106-110 and the data source 102 and/or the system 104 may interact to efficiently identify a time when both the provider and a user are available to schedule an appointment. For example, if a patient is at a provider's office and is needing to schedule an appointment, the user (e.g., a patient or customer) associated with the first access device 106 may enable a short range communication protocol and, thereafter, enable the transfer of a copy of the patient's electronic schedule from the first access device 106 to the data source 102 and/or the system 104. Once received, to identify or schedule an appointment for the patient, the data source 102 and/or the system 104 may perform processes to compare and/or merge the patient's electronic schedule with the provider's electronic schedule. The provider's electronic schedule may be accessible to and/or stored at the data source 102 and/or the system 104.

In some examples, the processes include identifying an open time slot on the provider's schedule. The data source 102 and/or the system 104 may identify the open time slot on the provider's schedule based on some criteria. For example, the criteria may be associated with identifying an open time slot that is the closest to the current date. In other examples, the criteria may be associated with identifying an open time slot based on a recommended follow-up appointment time such as six-weeks from the current date.

If an open time slot is identified on the provider's schedule meeting the criteria, the data source 102 and/or the system 104 may determine the patient's availability by identifying if there is a corresponding open time slot on the patient's schedule. Using the examples described herein, the patient's availability is not only based on identifying a corresponding open time slot in the patient's schedule, but also on other information. The other information may include the location and/or time of other appointments on the provider's schedule. Thus, instead of assuming that the patient is available to schedule in an open time slot just because there is a corresponding opening in the patient's schedule, the data source 102 and/or the system 104 also identify and factor in the time and/or location of other appointments on the patient's schedule when determining the patient's availability.

In some examples, in determining the patient's availability to schedule for an appointment in an open time slot on the provider's schedule, the data source 102 and/or the system 104 may identify other appointments on the patient's schedule around the open time slot and then, depending on the time and/or location of those other appointments, the data source 102 and/or the system 104 may either schedule or not schedule the patient for the appointment at that time. For example, if the data source 102 and/or the system 104 determines that the time and/or location of one or more of the other patient appointments does not leave adequate travel time for the patient to make the appointment, the data source 102 and/or the system 104 may find another time at which to possibly schedule the appointment.

However, if the data source 102 and/or the system 104 determines that the user is available and then schedules the user in an appointment, the data source 102 and/or the system 104 may notify the user, via the first access device 106 of being scheduled for the appointment at that time. The data source 102 and/or the system 104 may notify the user of being scheduled for the appointment by adding the newly scheduled appointment to the patient's electronic schedule on the first access device 106, for example. Alternatively, the data source 102 and/or system 104 may transmit a request to the user, via the first access device 106, for the user to add the newly scheduled appointment to their schedule.

In some examples, prior to scheduling the patient in the appointment at the identified open time slot, the data source 102 and/or the system 104 may first require approval from the user. The approval may be obtained by conveying the proposed appointment time to the user, via the first access device 106, which then prompts the user to either accept or decline to be scheduled in that appointment. The user may accept or decline the proposed appointment time using a graphical user interface (GUI) of the first access device 106, and the user's response may be transmitted to the data source 102 and/or the system 104, for example. However, approval by the user to be scheduled in the appointment may be obtained in alternative ways. For example, a healthcare practitioner associated with the data source 102 and/or the system 104 may be prompted to ask the user whether or not the proposed appointment time is acceptable to them and, based on the user's response, the healthcare practitioner may convey this information to the data source 102 and/or the system 104.

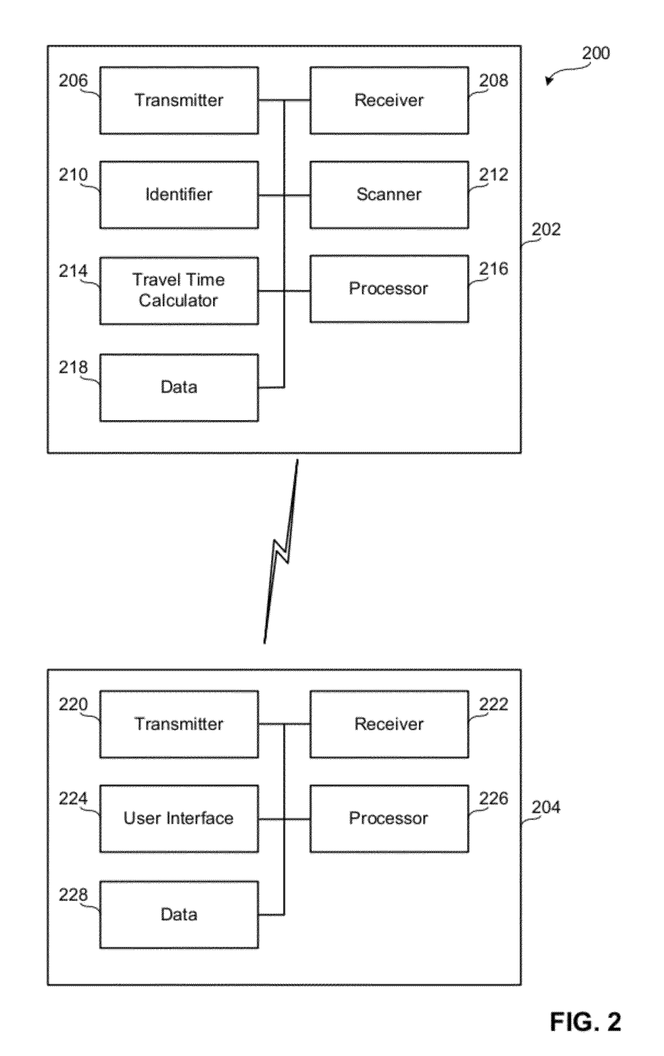

FIG. 2 is a block diagram of an example medical appointment or scheduling system 200 including an example scheduling system 202 and an example access device 204. The scheduling system 202 may be used to implement the data source 102 and/or the system 104 of FIG. 1. The access device 204 may be used to implement any of the access devices 106-110 of FIG. 1.

The scheduling system 202 may include a transmitter 206, a receiver 208, an identifier 210, a scanner 212, a travel time calculator 214, a processor 216 and a data source 218. The access device 204 may include a transmitter 220, a receiver 222, a user interface 224, a processor 226 and a data source 228. While an example manner of implementing the data source 102 and/or the system 104 of FIG. 1 and any one of the access devices 106-110 have been illustrated in FIG. 2, one or more of the elements, processes and/or devices illustrated in FIG. 2 may be combined, divided, re-arranged, omitted, eliminated and/or implemented in other ways. In some examples, the processor 216 may be integrated into the transmitter 206, the receiver 208, the identifier 210, the scanner 212, the travel time calculator 214, and/or the data source 218. Additionally or alternatively, in some examples, the processor 226 may be integrated into the transmitter 220, the receiver 222, the user interface 224 and/or the data source 228.

The transmitters 206 and/or 220, the receivers 208 and/or 222, the identifier 210, the scanner 212, the travel time calculator 214, the processors 216 and/or 226, the user interface 224 and/or the data sources 218 and/or 228 and, more generally, the example medical scheduling or appointment system 200 may be implemented by hardware, software, firmware and/or a combination of hardware, software and/or firmware. Thus, the transmitters 206 and/or 220, the receivers 208 and/or 222, the identifier 210, the scanner 212, the travel time calculator 214, the processors 216 and/or 226, the user interface 224 and/or the data sources 218 and/or 228 and, more generally, the example medical scheduling or appointment system 200 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the transmitters 206 and/or 220, the receivers 208 and/or 222, the identifier 210, the scanner 212, the travel time calculator 214, the processors 216 and/or 226, the user interface 224 and/or the data sources 218 and/or 228 and, more generally, the example medical scheduling or appointment system 200 are hereby expressly defined to include a tangible medium such as a memory, DVD, CD, Blu-ray, etc., storing the software and/or firmware. Further still, the example medical scheduling or appointment system 200 of FIG. 2 may include one or more elements, processes and/or devices in addition to, or instead of, those illustrated in FIG. 2, and/or may include more than one of any or all of the illustrated elements, processes and devices.

The scheduling system 202 and the access device 204 include the transmitters 206 and 220 and the receivers 208 and 222 that receive and convey data between the scheduling system 202 and the access device 204. For example, the transmitters 206 and 220 and the receivers 208 and 222 may interact to input an electronic copy of the patient's schedule onto the scheduling system 202. More specifically, upon request, the transmitter 220 of the access device 204 may obtain a copy of the patient's schedule and transmit the same to the receiver 208 of the scheduling system 202 where it may be temporarily stored at the data source 208, for example. In some examples, a user may enable either of the transmitter 220 and/or the receiver 222 of the access device 204 to communicate with the transmitter 206 and the receiver 208 of the scheduling system 202 by enabling a short range communication protocol of the access device 204 using, for example, the user interface 224.

The scheduling system 202 includes the identifier 210 that identifies a time slot when both the provider's schedule and the patient's schedule have an open time slot. In addition to the patient's schedule obtained from the access device 204, the identifier 210 may also identify scheduling information associated with the patient stored at the data source 218 and/or a location accessible by the scheduling system 202. Thus, appointments of the patient not specifically included on the patient's electronic schedule may be accounted for when identifying a time when both the provider and the patient are available. In some examples, the identifier 210 identifies an open time slot in the provider's and the patient's schedules by comparing the two schedules. In some examples, the identifier 210 identifies an open time slot in the provider's and the patient's schedules by merging the two schedules and identifying a time when both the provider and the patient are available. In some examples, the identifier 210 identifies an open time slot in the provider's schedule and, once found, identifies if the patient is also available at that time.

The scheduling system 202 includes the scanner 212 that scans the patient's schedule to identify other appointments that may interfere with the patient's ability to schedule in and/or make an appointment at the identified open time slot. In some examples, the scanner 212 scans the patient's schedule to identify an end and/or start time of an appointment proximate the identified open time slot. In some examples, the scanner 212 scans the patient's schedule to identify location identifying information related to other appointments in the patient's schedule that are proximate the open time slot. The location identifying information may include an address, a ZIP code, a building name, data associated with a location field, a department name or a location within a building. In some examples, the scanner 212 scans the patient's schedule to identify scheduling intervals between other appointments. For example, the scanner 212 may identify that the patient typically schedules their appointments one-hour apart. The intervals at which the patient typically schedules their appointments may be used in determining if the patient is available to schedule in the identified open time slot.

The scheduling system 202 includes a travel time calculator 214 that may calculate an estimated travel time between the provider and the other appointment identified using the scanner 212. In some examples, the travel time calculator 214 may use location identifying information extracted from the patient's schedule using the scanner 212, for example. In some examples, the travel time calculator 214 interacts with a navigation system by inputting at least some of the location identifying information into the navigation system and requesting that the navigation system estimate the travel time. In some examples, the travel time calculator 214 may take other factors into account when estimating the travel time such as the patient's mode of transportation and/or their ability level. The patient's mode of transportation and/or their ability level may be retrieved from either of the data sources 218 and/or 228 and/or any other database accessible by the scheduling system 202. If the other appointment is located at a department within the same healthcare facility where the appointment being scheduled is located, the travel time calculator 214 may estimate the travel time based on a travel time chart stored at the data source 218, for example.

The scheduling system 202 and the access device 204 include the processors 216 and 226 retrieving data, executing functionality and storing data at the scheduling system 202, the access device 204, the data source 102 of FIG. 1 and/or the system 104 of FIG. 1. In some examples, the processors 216 and/or 226 drive respective components of the scheduling system 202 and/or the access device 204. For example, the processor 216 may determine an availability of the patient to schedule in an appointment based on an end time of an appointment identified by the scanner 212 proximate the identified open time slot and an estimated travel time from that appointment calculated by the travel time calculator 214. In some examples, if no location identifying information is extractable from an appointment identified by the scanner 212 proximate the identified open time slot, the processor 216 may determine the patient's availability based on the scheduling interval identified by the scanner 212.

The processor 216 may drive the identifier 210 to identify appointments when both the provider and the patient are available. The processor 216 may drive the scanner 212 to scan the patient's schedule to identify other appointments and related data. The processor 216 may drive the travel time calculator 214 to calculate the estimated travel time between appointments. The processor 226 may drive the user interface 224 to provide information and functionality to a user input to control the access device 204, edit information, etc. In some examples, the user interface 224 may be configured as a graphical user interface (GUI). The GUI may be touch pad/screen integrated with the access device 204.

The scheduling system 202 and the access device 204 include one or more internal memories and/or data stores including the data sources 218 and 228. Data storage can include any variety of internal and/or external memory, disk, remote storage communicating with the scheduling system 202 and/or the access device 204.

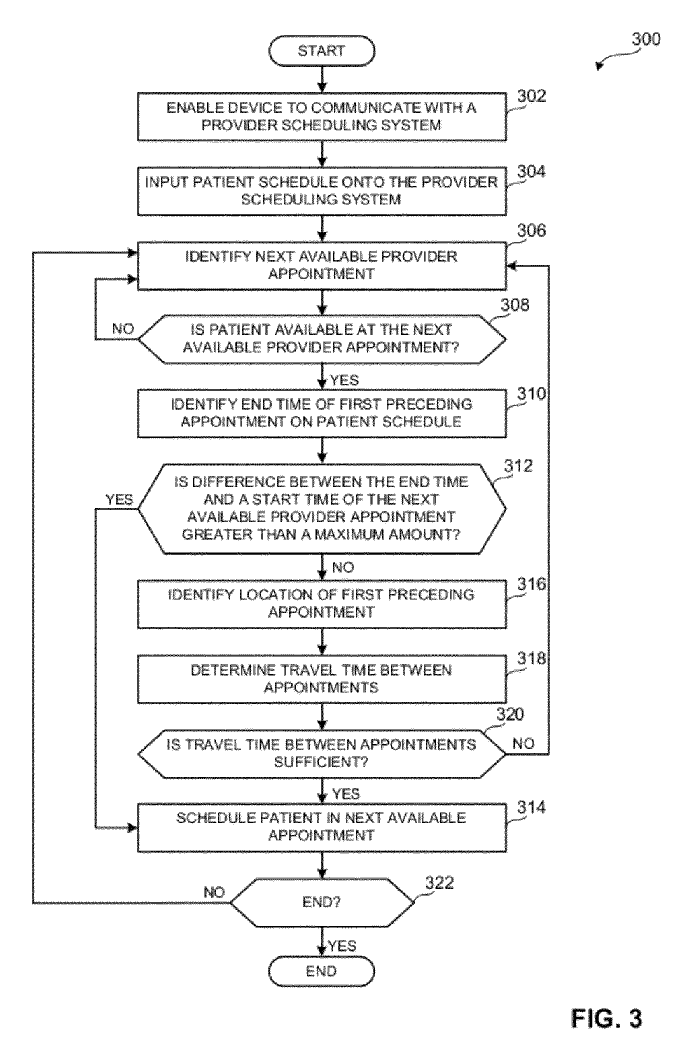

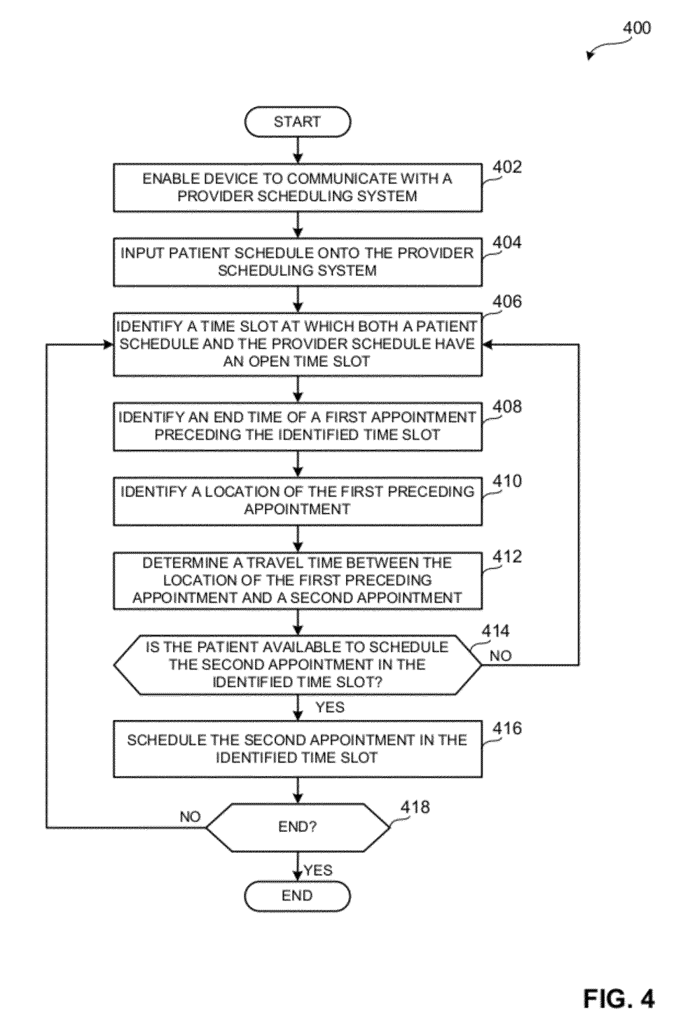

FIGS. 3-4 depict example flow diagrams representative of processes that may be implemented using, for example, computer readable instructions that may be used to identify medical appointments that are mutually agreeable using one or more access devices, a scheduling system, a data store and/or a system. The example processes of FIGS. 3-4 may be performed using a processor, a controller and/or any other suitable processing device. For example, the example processes of FIGS. 3-4 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIGS. 3-4 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 3-4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 3-4 may be implemented manually or as any combination(s) of any of the foregoing techniques, for example, any combination of firmware, software, discrete logic and/or hardware. Further, although the example processes of FIGS. 3-4 are described with reference to the flow diagrams of FIGS. 3-4, other methods of implementing the processes of FIGS. 3-4 may be employed. For example, the order of execution of the blocks may be changed, and/or some of the blocks described may be changed, eliminated, sub-divided, or combined. Additionally, any or all of the example processes of FIGS. 3-4 may be performed sequentially and/or in parallel by, for example, separate processing threads, processors, devices, discrete logic, circuits, etc.

FIG. 3 relates to an example method 300 that enables a patient and a provider to efficiently identify a time to schedule a mutually agreeable appointment. At block 302, the method 300 enables a device such as a mobile device or a laptop remote from the provider to communicate with a provider's scheduling system. (block 302). If the device is a mobile device, the device may communicate with the provider's scheduling system using a short range communication protocol such as Bluetooth®. If the device is a laptop, the device may communicate with the provider's scheduling system using, for example, the Internet. At block 304, the method 300 inputs the patient's schedule onto the provider's scheduling system. (block 304). For example, after enabling the short range communication protocol of the mobile device, the provider's scheduling system may prompt the mobile device to copy the patient's schedule and transmit the same to the provider's scheduling system. A copy of the patient's schedule may be stored temporarily at the provider's scheduling system, once received.

At block 306, the method 300 identifies the next available provider appointment. (block 306). In some examples, the method 300 may identify the next available provider appointment that is closest to the current date. In other examples, the method 300 may identify the closest available provider appointment to a suggested follow-up date such as eight-weeks from the current date.

If the method 300 identifies the next available appointment at block 306, the method 300 then determines if the patient is available at the identified next available provider appointment. (block 308). If the method 300 determines that the patient is not available at the identified next provider appointment based on the patient's schedule, control returns to block 306. However, if method 300 determines that the patient is available at the identified next provider appointment based on the patient's schedule, control moves to block 310.

At block 310, the method 300 identifies an end time of a first preceding appointment on the patient's schedule. (block 310). For example, if the identified next available provider appointment is on Nov. 19, 2010, at 10:00 am and the patient's first preceding appointment is on that date between 8:00 am and 9:00 am, the method 300 will identify the end time of the first preceding appointment as being at 9:00 am on Nov. 19, 2010. In other examples, if the identified next available provider appointment is on Nov. 19, 2010, at 10:00 am and the patient's first preceding appointment from that date is between 8:00 am and 9:00 am on November 15, 2010, the method 300 will identify the end time of the first preceding appointment as being at 9:00 am on Nov. 15, 2010.

At block 312, the method 300 determines if the end time of first preceding appointment and the start time of the next available appointment is greater than a maximum amount. (block 312). The maximum amount may be different or the same for different patients. In some examples, the maximum amount may be based on user input and/or data accessible to the examples described herein. For example, if the method 300 identifies that the difference between the end time and the start time is one-hour, the method 300 may determine that that amount of time is less than the maximum. However, if the difference between the end time and the start time is twenty four hours, the method 300 may determine that that amount of time is greater than the maximum.

If the method 300 determines that the difference between the end time and the start time is greater than the maximum, control advances to block 314 and the patient is then scheduled in the next available appointment. (block 314). However, if the method 300 determines that the difference between the end time and the start time is less than the maximum, control advances to block 316. At block 316, the method 300 identifies the location of the first preceding appointment. (block 316). For example, the method 300 may identify the location of the first preceding appointment by scanning for location identifying information contained in and/or associated with the patient's schedule. Additionally or alternatively, the method 300 may identify and/or assume the location of the first preceding appointment based on the time of day (e.g., during working hours, evening, etc.) at which that appointment is scheduled.

At block 318, the method 300 may determine the travel time between the appointments. (block 318). In some examples, the method 300 may determine the travel time between the first preceding appointment and the location of the provider by inputting the location identifying information extracted from the patient's schedule and the location of the provider into a navigation system. The navigation system may calculate an estimated travel time and convey that estimation to the provider's scheduling system, for example. In some examples, the method 300 may additionally use other factors when determining the travel time between the two locations. These other factors may include the patient's intended mode of travel, the patient's physical condition, the patient's age and/or any disabilities of the patient.

At block 320, the method 300 determines if the travel time is sufficient between the appointments for the patient to make that appointment. (block 320). If the method 300 determines that the travel time is sufficient, control advances to block 314 and the patient is then scheduled in the next available appointment. (block 314).

However, if the method 300 determines that the travel time is not sufficient, control returns to block 306.

At block 322, the method 300 determines whether or not to return to block 306. (block 322). Otherwise the example method 300 is ended.

FIG. 4 relates to an example method 400 that enables a patient and a provider to efficiently identify a time to schedule a mutually agreeable appointment. At block 402, the method 400 enables a device such as a mobile device or a laptop remote from the provider to communicate with a provider's scheduling system. (block 402). At block 404, the method 400 inputs the patient's schedule onto the provider's scheduling system. (block 404). For example, after enabling the short range communication protocol of the mobile device, the provider's scheduling system may prompt the mobile device to copy the patient's schedule and transmit the same to the provider's scheduling system. A copy of the patient's schedule may be stored temporarily at the provider's scheduling system, once received.

At block 406, the method 400 identifies a time slot at which both the patient's schedule and the provider's schedule have an open time slot. (block 406). In some examples, the method 400 may identify the open time slot by merging the patient's schedule and the provider's schedule and identifying a time when both the provider and the patient are available. In other examples, the method 400 may compare the two schedules to identify a time when both the provider and the patient are available. In other examples, the method 400 may identify an open time slot in the provider's schedule and, once found, identify if the patient is also available at that time.

At block 408, the method 400 may identify an end time of a first appointment preceding the identified time slot. (block 408). Additionally or alternatively, the method 400 may identify a start time of a first appointment subsequent the identified time slot. For example, if the identified next available provider appointment is on Nov. 19, 2010, at 10:00 am and the patient's first preceding appointment is on that date between 8:00 am and 9:00 am, the method 400 will identify the end time of the first preceding appointment as being at 9:00 am on Nov. 19, 2010. In other examples, if the identified next available provider appointment is on Nov. 19, 2010, at 10:00 am and the patient's first subsequent appointment is on that date between 11:00 am and 12:00 am, the method 400 will identify the start time of the first subsequent appointment as being at 11:00 am on Nov. 19, 2010.

At block 410, the method 400 identifies a location of the first preceding appointment. Additionally or alternatively, the method 400 may identify a location of the first subsequent appointment. The method 400 may identify the location of either the first preceding and/or subsequent appointment by scanning for location identifying information contained in and/or associated with the patient's schedule. Additionally or alternatively, the method 400 may identify and/or assume the location of either the first preceding or subsequent appointment based on the time of day (e.g., during working hours, evening, etc.) at which that appointment is scheduled.

At block 412, the method 400 determines an estimated travel time between the location of the first preceding appointment and a second appointment. (block 412). The second appointment is the appointment that may be scheduled in the open time slot. Additionally or alternatively, the method 400 may determine a travel time between the location of the first subsequent appointment and a second appointment.

The method 400 may calculate an estimated travel time using a navigation system and/or by accessing a travel time chart, etc. The method 400 may additionally use other factors when determining the travel time between the two locations. These other factors may include the patient's intended mode of travel, the patient's physical condition, the patient's age and/or any disabilities of the patient.

At block 414, the method 400 determines whether or not the patient is available to schedule the second appointment in the identified time slot. In some examples, the method 400 may determine whether or not the patient is available to schedule the second appointment in the identified time slot by determining whether or not the travel time is sufficient between the appointments for the patient to make that appointment. If the identified appointment is prior to the open time slot, the method 400 may determine whether or not the patient will be able to make the appointment if scheduled in the identified time slot. If the identified appointment is subsequent to the open time slot, the method 400 may determine whether or not the patient will be able to make the subsequent appointment if an appointment is scheduled in the identified time slot. If the method 400 determines that the patient is available to schedule the second appointment in the identified time slot, control advances to block 416, and the patient is scheduled for the second appointment in the identified time slot. (block 416). However, if the method 400 determines that the patient is not available to schedule the second appointment in the identified time slot, control returns to block 406.

At block 480, the method 400 determines whether or not to return to block 406. (block 418). Otherwise the example method 400 is ended.

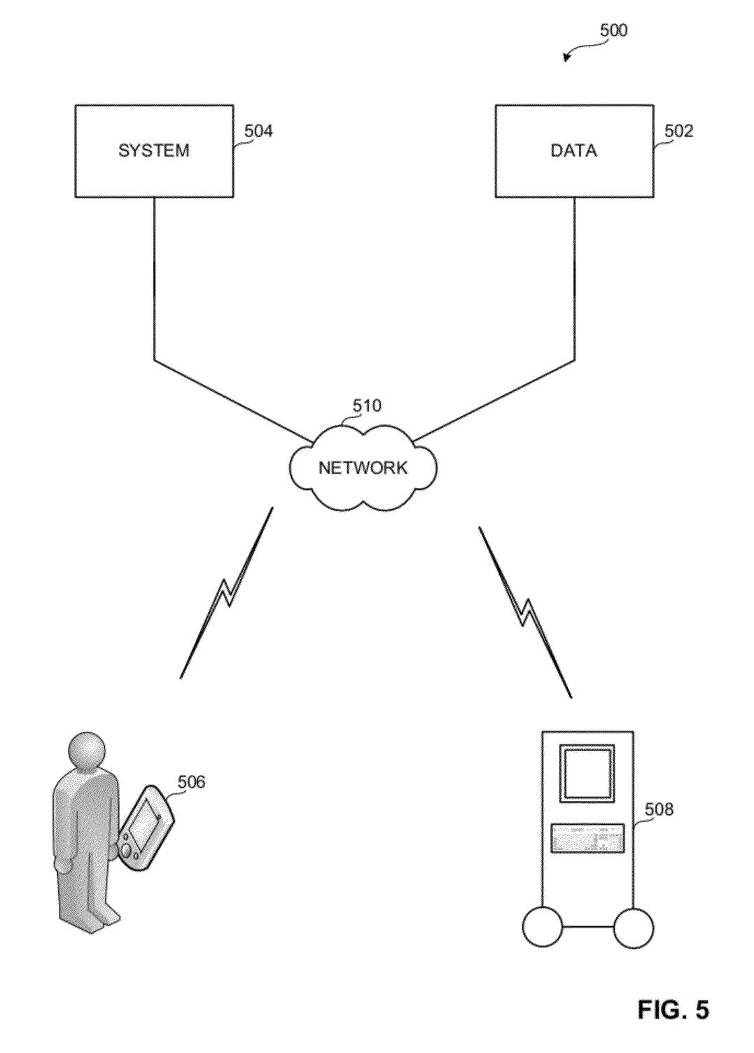

FIG. 5 depicts an example reminder system 500 including a data store or source 502 and a system 504. One or both of the data source 502 and/or the system 504 may interact with an access device 506 and/or an apparatus 508. In some examples, the data source 502 and/or the system 504 can be implemented in a single system. In some examples, the data source 502 and/or the system 504 may be wholly or partially implemented in the access device 506 and/or the apparatus 508. In some examples, the data source 502 and/or the system 504 can communicate with one or more of the access device 506 and/or the apparatus 508 via a network 510. In some examples, one or more of the access device 506 and/or the apparatus 508 can communicate with the data source 502 and/or the system 504 via the network 510. The network 510 may be implemented by, for example, the Internet, an intranet, a private or personal network, a wired or wireless Local Area Network, a wired or wireless Wide Area Network, a cellular network and/or any other suitable network.

One or more of the access device 506 and/or the apparatus 508 may provide scheduling information and/or location identifying information to the reminder system 500 to facilitate identifying if there remains adequate travel time for a user associated with the access device 506 and/or the apparatus 508 to be present at an appointment in which they are expected. In some examples, the data source 102 can receive scheduling information and/or location identifying information from one of the access device 506 and/or the apparatus 508. In some examples, the system 504 can receive scheduling information and/or location identifying information from one of the access device 506 and/or the apparatus 508. The data source 502 and/or the system 504 can be implemented using a system such as a PACS, RIS, HIS, CVIS, EMR, archive, data warehouse, etc.

The access device 506 can be implemented using a workstation (e.g., a laptop, a desktop, a tablet computer, etc.) or a mobile device, for example. The apparatus 508 may implemented as a machine, a healthcare apparatus, a portable X-ray machine, etc.

In some example, a user's location ahead of a scheduled appointment may vary. For example, for a 3:00 pm standing appointment, at 2:15 pm the user may sometimes be approximately 15 minutes away from the appointment's location while at other times the user may be approximately 45 minutes away from the appointment's location. Thus, reminders that are at a fixed time ahead of the standing appointment such as 10 minutes ahead the appointment start time may not be appropriate, because the user may be reminded too late.

In such instances, using the examples described herein, one or more of the access device 506, the apparatus 508 and the data source 502 and/or the system 504 may interact to efficiently identify the start time of an appointment where a user associated with the access device 506 and/or the apparatus 508 is to be present. In some examples, one or more of the access device 506, the apparatus 508 and the data source 502 and/or the system 504 may interact to efficiently identify the current location of the access device 506 and/or the apparatus 508. In some examples, using the examples described herein, one or more of the access device 506, the apparatus 508 and the data source 502 and/or the system 504 may interact to timely alert the user associated with the access device 506 and/or a person responsible for moving the apparatus 508 by taking travel time into account from the current location of the user and/or the apparatus 508.

In some examples, the upcoming appointment may be identified by the data source 502 and/or the system 504 associated with a healthcare scheduling system and, once identified, a notification may be conveyed to the user at the access device 506 of the upcoming appointment. The upcoming appointment may be an appointment in which the user associated with the access device 506 is to be present and/or an appointment at which the apparatus 508 is to be present. In some examples, once an upcoming appointment is identified in which the apparatus 508 is to be present, the access device 506, the apparatus 508, the data source 502 and/or the system 504 may perform processes to ensure that the user at the access device 506 is timely and/or dynamically reminded of the upcoming appointment with enough time to ensure the apparatus 508 is at the upcoming appointment on time.

In other examples, the upcoming appointment may be identified by the access device 506 and/or the data source 502 and/or the system 504 wholly or partially implemented in the access device 506. Once the upcoming appointment is identified, the access device 506, the apparatus 508, the data source 502 and/or the system 504 may be perform processes to ensure that the user at the access device 506 is timely and/or dynamically reminded of the upcoming appointment with enough time to ensure the user is at the appointment's location on time.

In some examples, the processes may include extracting location identifying information, other information and/or start time information from the upcoming appointment. If no location identifying information is identifiable, the processes may include identifying location identifying information from other appointments (e.g., previous appointments, future appointments) associated with the upcoming appointment and having location identifying information contained therein.

The processes may also include determining the location of the user using functionality of the access device 506, the apparatus 508, the data source 502 and/or the system 504. In some examples, the processes may include determining the location of the apparatus 508 using functionality of the access device 506, the apparatus 508, the data source 502 and/or the system 504. In some examples, the location of the user and/or the apparatus 508 may be determined on a regular basis from an amount of time ahead of the upcoming appointment until the start time of the appointment. Based on information extracted from the upcoming appointment and the user's and/or apparatus's 508 current location and information related thereto, the processes may include determining a travel time from the user's current location to the location of the upcoming appointment and/or a travel time to move the apparatus 508 from its current location to the location of the upcoming appointment. In some examples, the processes may include inputting the user's current location and the location of the upcoming appointment into a navigation system to calculate an estimated travel time between the two locations. The estimated travel time may be affected by the user's mode of the transportation, traffic conditions, the apparatus type, etc.

Based on the current time, the start time of the upcoming appointment and/or the estimated travel time from where the user and/or the apparatus 508 is currently located to where the appointment is to be held, the processes may include reminding the user and/or the person responsible for moving the apparatus 508 of the upcoming appointment using the access device 506. For examples, if the data source 502, the system 504, the access device 506 and/or the apparatus 508 determine that a difference between the current time and a start time of the upcoming appointment are different and/or significantly different, the data source 502, the system 504, the access device 506 and/or the apparatus 508 may not initiate and/or convey a reminder to the user at the access device 506. However, if the data source 502, the system 504, the access device 506 and/or the apparatus 508 determine that a difference between the current time and a start time of the upcoming appointment are similar and/or significantly similar (e.g., within 5-minutes, 10-minutes, etc.), the data source 502, the system 504, the access device 506 and/or the apparatus 508 may initiate and/or convey a reminder to the user at the access device 506.

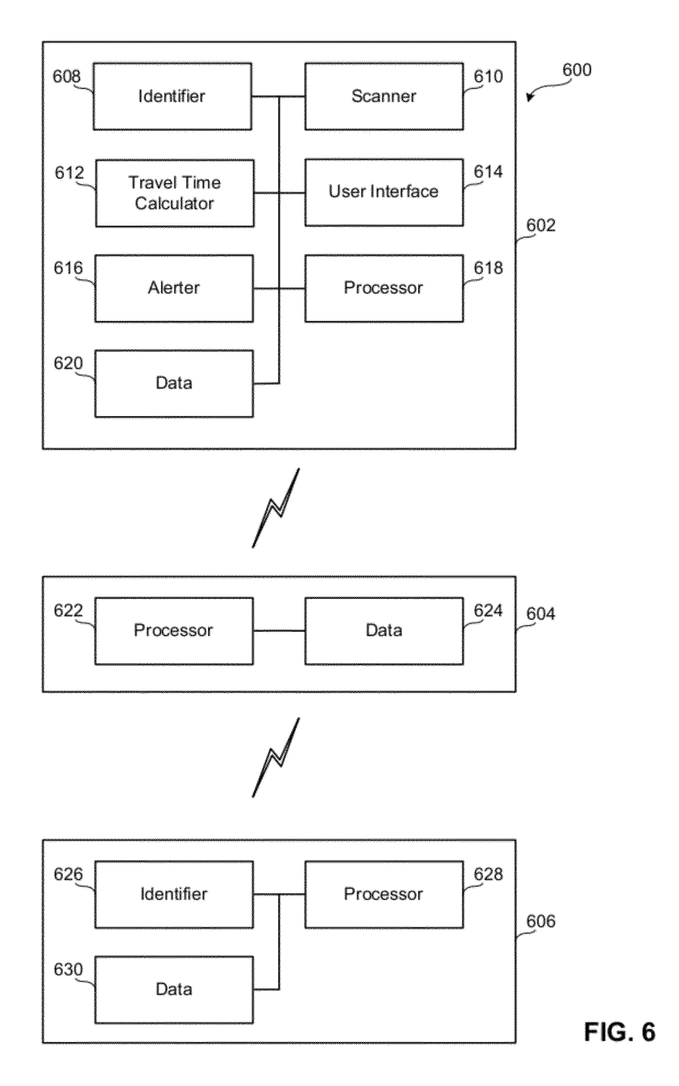

FIG. 6 is a block diagram of an example reminder system 600 including an example access device 602, an example scheduling system 604 and an example apparatus 606. The access device 602 may be used to implement the access device 506 of FIG. 5. The scheduling system 604 may be used to implement the data source 502 and/or the system 504. The apparatus 606 may be used to implement the apparatus 508 of FIG. 5.

The access device 602 may include an identifier 608, a scanner 610, a travel time calculator 612, a user interface 614, an alerter 616, a processor 618 and a data source 620. The scheduling system 604 may include a processor 622 and a data source 624. The apparatus 606 may include an identifier 626, a processor 628 and a data source 630. While an example manner of implementing the data source 502 and/or the system 504, the access device 506 and/or the apparatus 508 have been illustrated in FIG. 6, one or more of the elements, processes and/or devices illustrated in FIG. 6 may be combined, divided, re-arranged, omitted, eliminated and/or implemented in other ways. In some examples, the processor 618 may be integrated into the identifier 608, the scanner 610, the travel time calculator 612, the user interface 614, the alerter 616, the processor 618 and/or the data source. Additionally or alternatively, the processor 622 may be integrated into the data source 624. Additionally or alternatively, the processor 628 may be integrated into the identifier 626 and/or the data source 630. The identifiers 608 and/or 626, the scanner 610, the travel time calculator 612, the user interface 614, the alerter 616, the processors 618, 622 and/or 628 and the data sources 620, 624 and/or 630 and, more generally, the example reminder system 600 may be implemented by hardware, software, firmware and/or a combination of hardware, software and/or firmware. Thus, the identifiers 608 and/or 626, the scanner 610, the travel time calculator 612, the user interface 614, the alerter 616, the processors 618, 622 and/or 628 and the data sources 620, 624 and/or 630 and, more generally, the example reminder system 600 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the identifiers 608 and/or 626, the scanner 610, the travel time calculator 612, the user interface 614, the alerter 616, the processors 618, 622 and/or 628 and the data sources 620, 624 and/or 630 and, more generally, the example reminder system 600 are hereby expressly defined to include a tangible medium such as a memory, DVD, CD, Blu-ray, etc., storing the software and/or firmware. Further still, the example reminder system of FIG. 6 may include one or more elements, processes and/or devices in addition to, or instead of, those illustrated in FIG. 6, and/or may include more than one of any or all of the illustrated elements, processes and devices.

In some examples, the access device 602 includes the identifier 608 that identifies an upcoming appointment on a user's schedule stored at the data source 620. In some examples, the scheduling system 604 includes the processor 622 that may implement an identifier at the scheduling system 604 to identify an upcoming appointment of the user associated with the access device 602 stored at the data source 624 and convey a notice regarding the same to the access device 602. In some examples, the identifier 608 may identify the current location of the access device 602. In some examples, the scheduling system 604 includes the processor 622 that may implement an identifier at the scheduling system 604 to identify an upcoming appointment at which the apparatus is to be present. In some examples, the apparatus 606 may include the identifier 626 that may identify and/or convey the current location of the apparatus 606 to the access device 602 and/or the scheduling system 604.

In some examples, the access device 602 includes the scanner 610 that scans the information related to the upcoming appointment to identify a start time of the upcoming appointment. In some examples, the scanner 610 may scan the information relating to the upcoming appointment to identify location identifying information. The location identifying information may include an address, a ZIP code, a building name, data associated with a location field, a department name or a location within a building. In some examples, the scheduling system 604 includes the processor 622 that implements a scanner to identify start time and/or location identifying information of the upcoming appointment.

The access device 602 includes the travel time calculator 612 that may calculate an estimated travel time between the current location of the access device 602 and a location of the upcoming appointment identified using the scanner 610. In some examples, the travel time calculator 612 may use location identifying information extracted from the user's schedule using the scanner 610, for example. In some examples, the travel time calculator 612 interacts with a navigation system by inputting at least some of the location identifying information into the navigation system and requesting that the navigation system estimate the travel time. In some examples, the scheduling system 604 includes the processor 622 that may implement a travel time calculator to calculate an estimated travel time between a current location of the apparatus 606 and a location of the upcoming appointment where the apparatus 606 is to be used.

The access device 602 includes the alerter 616 that may alert a user of the upcoming appointment if the travel time is within a threshold of the amount of time from the current time to the start time of the upcoming appointment. In some examples, the alert may be conveyed to the user via the user interface 614. In some examples, the appointment may be an appointment in which a user associated with the access device 602 is to be present. In some examples, the appointment may be an appointment where the apparatus 606 is to be present.

The access device 602, the scheduling system 604 and/or the apparatus 606 include the processors 618, 622 and 628 retrieving data, executing functionality and storing data at the access device 602, the scheduling system 604, the apparatus 606, the data source 502 of FIG. 5 and/or the system 504 of FIG. 5. In some examples, the processors 618, 622 and/or 628 drive respective components of the scheduling system 202 and/or the access device 204. The processor 618 may drive the user interface 618 to provide information and functionality to a user input to control the access device 204, receive alerts, etc. In some examples, the user interface 618 may be configured as a graphical user interface (GUI). The GUI may be touch pad/screen integrated with the access device 602.

The access device 602, the scheduling system 604 and/or the apparatus 606 include one or more internal memories and/or data stores including the data sources 620, 624 and 630. Data storage can include any variety of internal and/or external memory, disk, remote storage communicating with the access device 602, the scheduling system 604 and/or the apparatus 606.

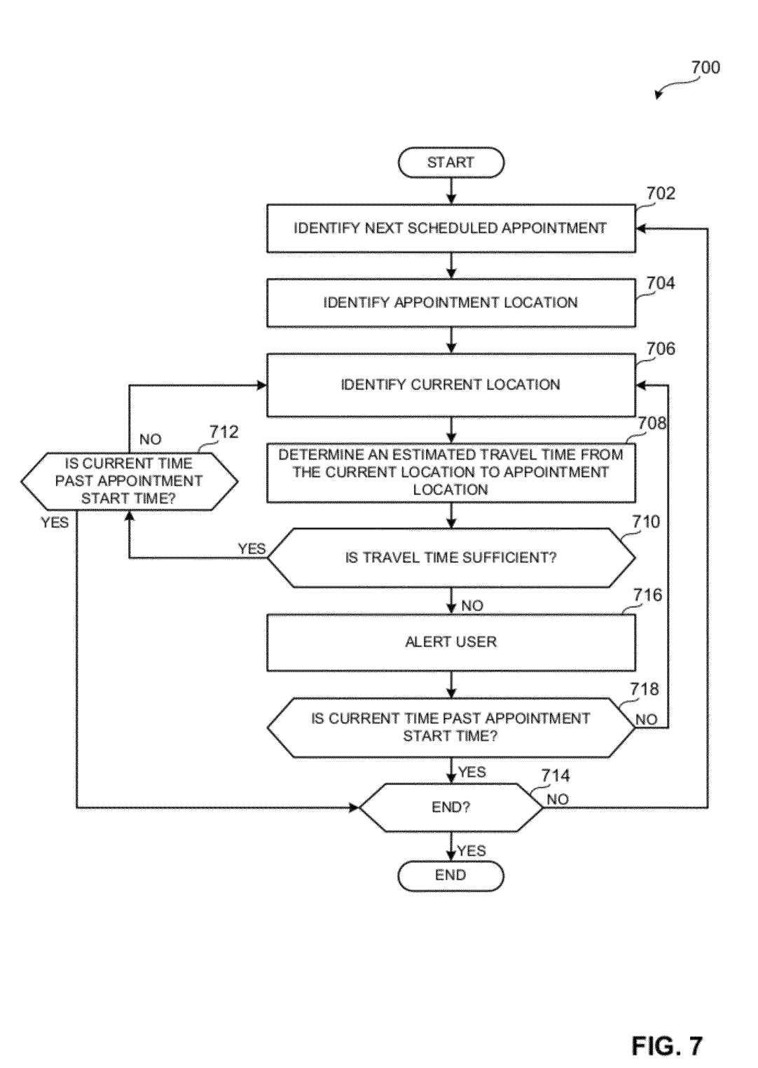

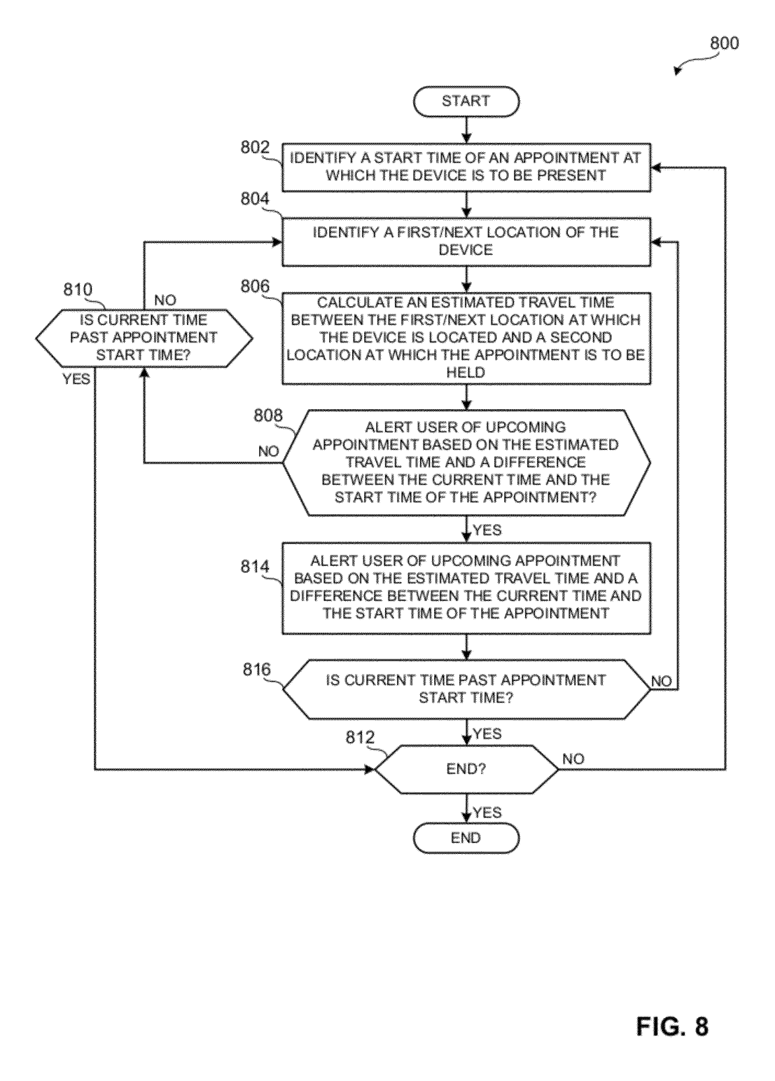

FIGS. 7-8 depict example flow diagrams representative of processes that may be implemented using, for example, computer readable instructions that may be used to provide dynamic reminders using an access device, an apparatus, a scheduling system, a data store and/or a system. The example processes of FIGS. 7-8 may be performed using a processor, a controller and/or any other suitable processing device. For example, the example processes of FIGS. 7-8 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIGS. 7-8 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 7-8 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 7-8 may be implemented manually or as any combination(s) of any of the foregoing techniques, for example, any combination of firmware, software, discrete logic and/or hardware. Further, although the example processes of FIGS. 7-8 are described with reference to the flow diagrams of FIGS. 7-8, other methods of implementing the processes of FIGS. 7-8 may be employed. For example, the order of execution of the blocks may be changed, and/or some of the blocks described may be changed, eliminated, sub-divided, or combined. Additionally, any or all of the example processes of FIGS. 7-8 may be performed sequentially and/or in parallel by, for example, separate processing threads, processors, devices, discrete logic, circuits, etc.

FIG. 7 relates to an example method 700 that provides dynamic reminders to a user. At block 702, the method 700 identifies the next scheduled appointment. In some examples, the schedule may be a schedule stored at a mobile device. In some examples, the schedule may be a schedule stored at a healthcare facility. The appointment may be an appointment where a user is to be present and/or an apparatus is to be present.

At block 704, the method 700 identifies the appointment location. In some examples, the appointment location may be identified by extracting location identifying information from an appointment entry. At block 706, the method 700 identifies the current location of, for example, a user associated with an access device and/or an apparatus to be used during the upcoming appointment. At block 708, the method 700 determines an estimated travel time from the current location to the appointment location. The estimated travel time may be determined using a navigation system and/or a travel time chart with pre-determined travel times between locations. In some examples, the travel time may be an estimated travel time for a user to travel to the appointment from the user's identified location. In some examples, the travel time may be an estimated travel time for a person responsible for moving an apparatus to move the apparatus to the next appointment where it is to be used.

At block 710, the method 700 determines if the travel time is sufficient. For example, the method 700 may determine that the travel time is sufficient if the start time of the appointment is 5:00 pm, the current time is 3:00 pm and the travel time to the appointment is 15-minutes. If the travel time is determined to be sufficient, control moves to block 712.

At block 712, the method 700 determines whether or not the current time is past the appointment start time. If the method 700 determines that the current time is past the appointment start time, control advances to block 714. However, if the method 700 determines that the current time is not past the appointment start time, control returns to block 706.

If the method 700 determines that the travel time is insufficient, control advances to block 716, and the user is alerted of the next scheduled appointment. In some examples, the user may be alerted using functionality of a mobile device such as text message, vibration, etc. At block 718, the method 700 determines whether or not the current time is past the appointment start time. If the method 700 determines that the current time is not past the appointment start time, control returns to block 706. However, if the method 700 determines that the current time is past the appointment start time, control advances to block 714. At block 714, the method 700 determines whether or not to return to block 702. Otherwise the example method 700 is ended.

FIG. 8 relates to an example method 800 that provides dynamic reminders to a user. At block 802, the method 800 identifies a start time of an appointment at which a device is to be present. In some examples, the device may be a mobile device associated with a user. In other examples, the device may be a machine to be used during an appointment.

At block 804, the method 800 identifies a first location of the device. For example, the first location of the device may be identified using one or more geolocation and/or tracking techniques such as global positioning (GPS), RFID, near field detection, infrared, cellular triangulation, etc. At block 806, the method 800 calculates an estimated travel time between the first location at which the device is located and a second location at which the appointment is to be held. The location at which the appointment is to be held may be determined by extracting location identifying information from an entry associated with the appointment. In some examples, the estimated travel time may be determined using a navigation system and/or a travel time chart with pre-determined travel times between locations. In some examples, the travel time may be an estimated travel time for a user to travel to the appointment from the user's identified location. In some examples, the travel time may be an estimated travel time for a person responsible for moving an apparatus to move the apparatus to the next appointment where it is to be used.

At block 808, the method 800 determines whether or not to alert the user of the upcoming appointment based on the estimated travel time and a difference between the current time and the start time of the appointment. For example, the method 800 may determine not to alert the user if the method determines that travel time is sufficient to make it to the appointment on time. If the method 800 determines not to alert the user, control moves to block 810.

At block 810, the method 800 determines whether or not the current time is past the appointment start time. If the method 800 determines that the current time is past the appointment start time, control advances to block 812. However, if the method 800 determines that the current time is not past the appointment start time, control returns to block 804.

If the method 800 determines to alert the user, control advances to block 814, and the user is alerted of the upcoming appointment. At block 816, the method 800 determines whether or not the current time is past the appointment start time. If the method 800 determines that the current time is not past the appointment start time, control returns to block 804. However, if the method 800 determines that the current time is past the appointment start time, control advances to block 812. At block 812, the method 800 determines whether or not to return to block 802. Otherwise the example method 800 is ended.

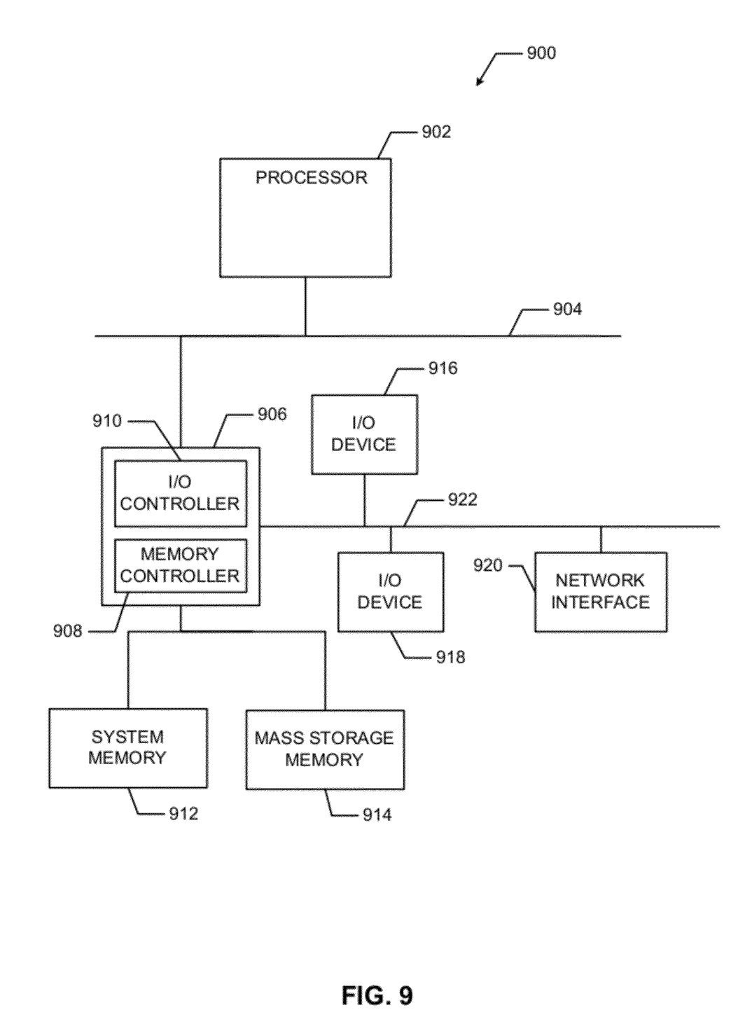

FIG. 9 is a block diagram of an example processor system 900 that may be used to implement the systems and methods described herein. As shown in FIG. 9, the processor system 900 includes a processor 902 that is coupled to an interconnection bus 904. The processor 902 may be any suitable processor, processing unit or microprocessor. Although not shown in FIG. 9, the processor system 900 may be a multi-processor system and, thus, may include one or more additional processors that are identical or similar to the processor 902 and that are communicatively coupled to the interconnection bus 904.

The processor 902 of FIG. 9 is coupled to a chipset 906, which includes a memory controller 908 and an input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914.

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device including hard disk drives, optical drives, tape storage devices, etc.

The I/O controller 910 performs functions that enable the processor 902 to communicate with peripheral input/output (I/O) devices 916 and 918 and a network interface 920 via an I/O bus 922. The I/O devices 916 and 918 may be any desired type of I/O device such as, for example, a keyboard, a video display or monitor, a mouse, etc. The network interface 920 may be, for example, an Ethernet device, an asynchronous transfer mode (ATM) device, an 802.11 device, a DSL modem, a cable modem, a cellular modem, etc. that enables the processor system 900 to communicate with another processor system.

While the memory controller 908 and the I/O controller 910 are depicted in FIG. 9 as separate blocks within the chipset 906, the functions performed by these blocks may be integrated within a single semiconductor circuit or may be implemented using two or more separate integrated circuits.

The example methods and apparatus described herein relate to scheduling systems that identify an open time slot(s) in an electronic schedule of a first party and a second party and determine if one or both of the parties are available to schedule in the identified open time slot(s) based on other information from one or both of the parties schedules. More specifically, after identifying an open time slot, the examples described herein identify and factor in other appointments in one or both of the parties schedules proximate the identified open time slot to determine if the respective party can make an appointment in the identified open time slot. In some examples, this determination is based on a travel time between the two appointments. The examples described herein may be used in any suitable industry in which meetings are scheduled such as healthcare, automotive repair, hospitality, business, etc.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer-implemented method of scheduling a follow-up medical appointment, comprising:
enabling a mobile device associated with a patient to communicate with a provider scheduling system;
inputting a patient schedule onto the provider scheduling system;
identifying a time slot, using a computer, at which both the patient schedule and a provider schedule have an open time slot;
identifying an end time and a location of a first appointment of the patient preceding the open time slot based on the patient schedule;
determining an estimated travel time between the location of the first appointment and a location of a second appointment; and
determining a patient availability to schedule the second appointment in the open time slot based on the end time of the first appointment and the estimated travel time from the location of the first appointment to the location of the second appointment.

2. The method of claim 1, wherein enabling the mobile device to communicate with the provider scheduling system comprises enabling a short range communication protocol of the mobile device.

3. The method of claim 1, wherein inputting the patient schedule onto the provider scheduling system comprises obtaining a copy of the patient schedule and temporarily storing the patient schedule on the provider scheduling system.

4. The method of claim 3, the copy of the patient schedule being temporarily stored on a memory of the provider scheduling system.

5. The method of claim 1, wherein comparing the patient schedule and the provider schedule comprises identifying a provider available time slot on the provider schedule and determining if the patient is available during the provider available time slot based on the patient schedule.

6. The method of claim 1, wherein identifying the end time and location of the first appointment comprises scanning the patient schedule to identify location identifying information, the location identifying information comprising at least one of an address, a zip code, a building name, data associated with a location field, a department name, or a location within a building.

7. The method of claim 1, wherein determining the estimated travel time is at least partially based on identifying a scheduling interval between appointments on the patient schedule.

8. The method of claim 1, wherein determining the estimated travel time is based at least partially on a mode of transportation of the patient, the mode of transportation being identified based on at least one of patient input, a location of the follow-up appointment, or an ability level of the patient.

9. The method of claim 1, wherein determining the estimated travel time is based at least partially on an ability level of the patient, the ability level being identified from patient data accessible to a healthcare facility associated with the second appointment.

10. The method of claim 9, the data being stored on a memory at the healthcare facility.

11. The method of claim 1, wherein determining the estimated travel time comprises interacting with a navigation system or a travel time chart.

12. The method of claim 1, further comprising identifying one or more other medical appointments on the provider scheduling system associated with the patient and factoring the other medical appointments into the patient schedule when identifying the time slot.

13. A computer implemented method of automatically scheduling a medical appointment, comprising:
enabling a first device associated with a patient to communicate with a provider scheduling system;
inputting a patient schedule onto the provider scheduling system;
identifying a time slot, using a computer, at which both the patient schedule and a provider schedule have an open time slot;
identifying a time and a location of a first appointment proximate to the open time slot based on the patient schedule;
determining an estimated travel time between the location of the first appointment and a location of a second appointment; and
determining a patient availability to schedule the second appointment in the open time slot based on the time of the first appointment and the estimated travel time between the location of the first appointment and the location of the second appointment.

14. The method of claim 14, the first device comprising a mobile device, and the mobile device to communicate with the provider scheduling system using a short range communication protocol.

15. The method of claim 14, wherein identifying the time and the location of the first appointment comprises scanning the patient schedule to identify location identifying information, the location identifying information comprising at least one of an address, a zip code, a building name, data associated with a location field, a department name, or a location within a building.

16. The method of claim 14, wherein identifying the time of the first appointment comprises identifying an end time of a first appointment prior to the open time slot.

17. The method of claim 14, wherein identifying the time of the first appointment comprises identifying a start time of a first appointment subsequent to the open time slot.

18. A tangible computer-readable storage medium including executable instructions for execution using a processor, wherein the instructions, when executed, provide a scheduling system to schedule a medical appointment, the system comprising:
an identifier to identify a time slot at which both the patient schedule and the provider schedule have an open time slot, the patient schedule or a copy thereof being stored on a memory accessible by the processor;
a scanner to scan at least a portion of the patient schedule to identify an end time and a location of a first appointment prior to the open time slot; and
a processer to determine a patient availability to schedule a second appointment in the time slot based on the end time of the first appointment and an estimated travel time from the first appointment to the second appointment.

19. The tangible computer-readable storage medium of claim 18, wherein the processor is to determine the estimated travel time based at least partially on an ability level of the patient, the ability level being identified from patient data accessible to a healthcare facility associated with the second appointment.

20. The tangible computer-readable storage medium of claim 18, wherein the processor is to determine the estimated travel time by interacting with at least one of a navigation system or a travel time chart.
